(19) United States
(12) Patent Application Publication
(10) Pub. No.: US 2006/0038543 A1
(43) Pub. Date: Feb. 23, 2006

(54) DC/DC converters using dynamically-adjusted variable-size switches

(76) Inventors: Peter Hazucha, Beaverton, OR (US); Sung T. Moon, Hillsboro, OR (US); Gerhard Schrom, Hillsboro, OR (US); Tanay Karnik, Portland, OR (US); Vivek De, Beaverton, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/924,482

(22) Filed: Aug. 23, 2004

(51) Int. Cl. G05F 1/40

(52) U.S. Cl. 323/282

(57) ABSTRACT

DC/DC converters using dynamically adjusted variable size switches are described herein. In one embodiment, a power switch includes multiple switching elements coupled to each other, each of the switching elements independently switching to convert an input voltage to an output voltage of a DC/DC converter, and a duty cycle of the DC/DC converter being determined based on a duty cycle of each of the switching elements. Other methods and apparatuses are also described.

### FIELD

Embodiments of the invention relate to DC/DC converters; and more specifically, to DC/DC converters using dynamically-adjusted variable-size switches.

### BACKGROUND

Direct current to direct current (DC/DC) converters provide the capability to convert energy supplied by a power supply from one voltage and current level to another voltage and current level. Such circuits are widely employed in conjunction with computing platforms, such as personal computers, server nodes, laptop computers, and a variety of other computing systems. Such circuits are desirable because specifications for a processor typically employ lower voltages, such as 0.5 to 5 volts, and higher currents, such as reaching 50 to over 100 amps, that may change over a relatively wide range with a relatively high slew rate.

DC/DC converters are desirable for providing voltage regulation under these conditions for a variety of reasons. One reason is because such circuitry may be placed relatively close to the board components, resulting in the capability to provide low local voltage tolerances due to higher switching frequencies, single output topology, and a reduction in resistance from shorter electrical connections.

Typically, a small power switch is used for a DC/DC converter having a light load current, while a large power switch is used for a DC/DC converter having a heavy load current. However, such a design is typically implemented and manufactured prior to usage. Thus, the size of the power switch of a typical DC/DC converter cannot be changed dynamically in practice. As a result, a DC/DC converter designed for a heavy load may consume more power if the load of the DC/DC converter is light due to the large size of the power switch originally designed for a heavy load. Similarly, a DC/DC converter designed for a light load cannot occasionally handle a relatively heavy load.

### DESCRIPTION OF THE DRAWINGS

The invention may best be understood by referring to the following description and accompanying drawings that are used to illustrate embodiments of the invention. In the drawings:

FIG. 1 is a diagram illustrating the dependency of the loss as a function of the RMS (root mean square) current.

FIG. 2 is a diagram illustrating the dependency of the loss as a function of the conversion ratio.

FIG. 3 is a diagram illustrating an optimum switch size dependence on the RMS current.

FIG. 4 is a block diagram illustrating an example of a power switch of a DC/DC converter having multiple switching elements according to one embodiment.

FIG. 5 is a block diagram illustrating a DC/DC converter having a power switch with variable size according to one embodiment.

FIG. 6 is a flow diagram illustrating a process for operating a DC/DC converter according to one embodiment.

FIG. 7 is a block diagram of a computer example which may be used with an embodiment.

### DETAILED DESCRIPTION

DC/DC converters using dynamically adjusted variable size switches are described herein. In the following description, numerous specific details are set forth (e.g., such as logic resource partitioning/sharing/duplication implementations, types and interrelationships of system components, and logic partitioning/integration choices). However, it is understood that embodiments of the invention may be practiced without these specific details. In other instances, well-known circuits, software instruction sequences, structures and techniques have not been shown in detail in order not to obscure the understanding of this description.

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct contact with each other (e.g., physically, electrically, optically, etc.). “Coupled” may mean that two or more elements are in direct contact (physically, electrically, optically, etc.). However, “coupled” may also mean that two or more elements are not in direct contact with each other, but yet still co-operate or interact with each other.

A technique that reduces a total loss associated with power switches of a switching DC/DC converter is described herein. In one embodiment, the total loss is reduced by dynamically adjusting the active switch sizes of a power switch based on one or more operating conditions. This technique is applicable to switched-capacitor and switched-inductor based DC/DC converters utilizing controlled switches, such as, for example, metal oxide semiconductor field effect transistors (MOSFETs), junction FETs (JFETs), bipolar transistors (BJTs), etc. For such switches, there is usually a tradeoff between resistive loss that decreases with increasing switch size or as higher number of switches are connected in parallel, and switching loss that increases with increasing switch size due to larger capacitance of the control terminal (e.g. gate of a FET or base of a BJT).

As a result, the switch size or number of switches connected in parallel is fixed and selected in order to minimize the total loss at some specific operating conditions. Therefore, at some other operating conditions, the switch size may be sub-optimal and result in increased total loss and degraded efficiency. In DC/DC converters, the dominant power losses are switching losses of switches, resistive losses of switches, and losses associated with other components, such as, hysteresis loss, eddy current loss, resistive loss of inductors and capacitors, diode reverse recovery loss, etc.

The total power loss associated with controlled switches can be written as a sum of the switching and resistive loss which can be illustrated as follows:
P_{TOT}=P_{SW}+P_{RES}=ƒ×c_{SW}×V_{SW}²+R_{SW}×I_{RMS}²
The effective switched capacitance C_{SW} is proportional to transistor size W and effective switch resistance is inversely proportional to size W.

$${P}_{TOT} = f \times α W \times {V}_{SW}^{2} + \frac{β}{W} \times {I}_{RMS}^{2}$$

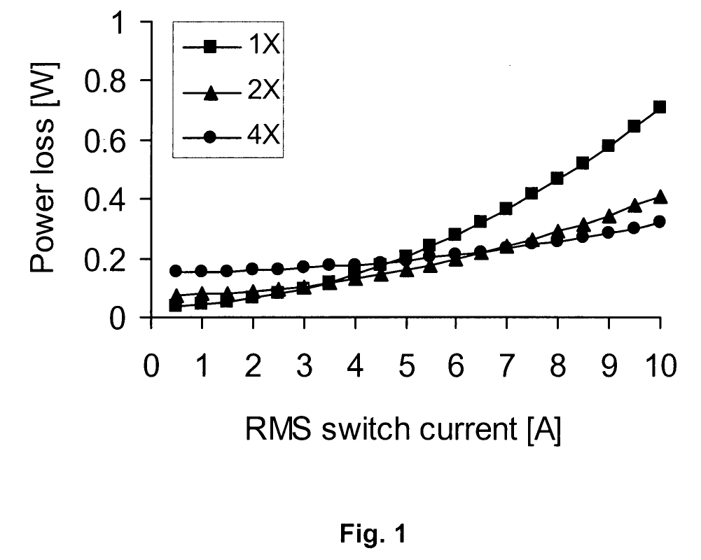

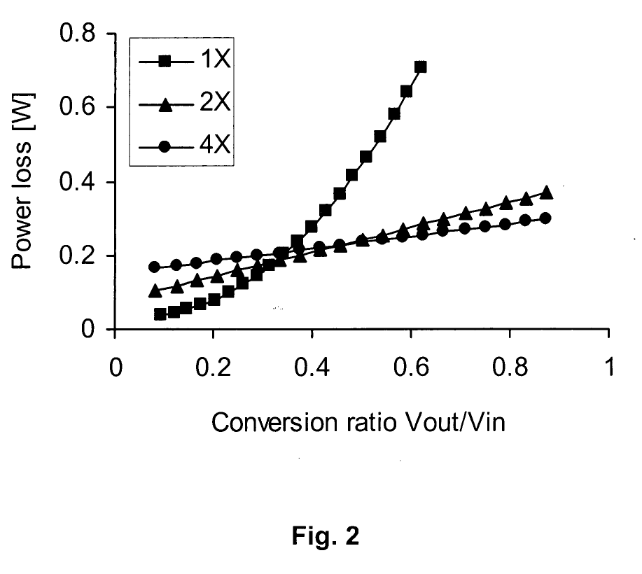

FIG. 1 is a diagram illustrating the dependency of the loss as a function of the RMS (root mean square) current, I_{RMS} for three different sizes W. For a range of currents, there is no single switch size that results in a minimum loss. Rather, a small size is preferred at low currents and a large size is preferred at large currents. For a typical DC/DC converter, such as a buck DC/DC converter, the RMS current is a function of voltage conversion ratio. Therefore, the loss and the preferred switch size vary with the conversion ratio. FIG. 2 is a diagram illustrating the dependency of the loss as a function of the conversion ratio.

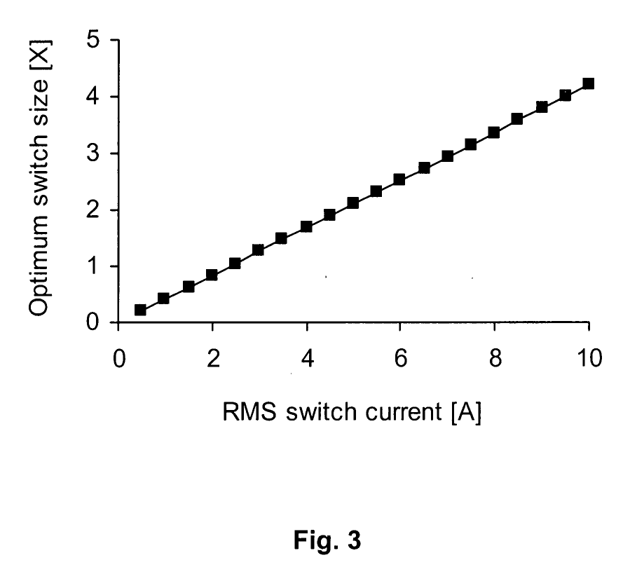

FIG. 3 is a diagram illustrating an optimum switch size dependence on the RMS current. This relationship may be illustrated as follows:

$${W}_{OPT} = \sqrt{\frac{β}{α} \frac{{I}_{RMS}^{2}}{f \times {V}_{SW}^{2}}} .$$

Since I_{RMS}, V_{SW}, ƒ, α, and β, depend on DC-DC converter input voltage V_{IN}, output voltage V_{OUT}, load current, duty cycle, and other parameters, the optimum switch size W_{OPT} will depend on the same parameters. According to one embodiment, some or all switches of a DC/DC converter are implemented as variable-size switches such that the optimum switch size can be dynamically selected based on operating conditions.

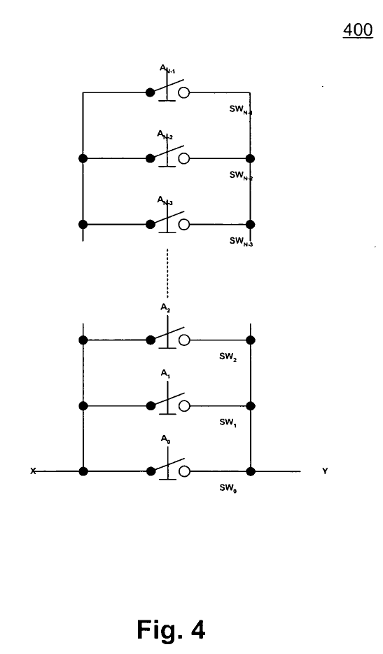

FIG. 4 is a block diagram illustrating an example of a power switch of a DC/DC converter having multiple switching elements according to one embodiment. In one embodiment, the power switch example 400 includes, but is not limited to, multiple switching elements coupled to each other, each of the switching elements independently switching to convert an input voltage to an output voltage of a DC/DC converter, and a duty cycle of the DC/DC converter being determined based on a duty cycle of each of the switching elements.

Referring to FIG. 4, the power switch example 400 includes multiple switching elements SW₀-SW_{N-1}. Each of the switching elements SW₀-SW_{N-1} is able to independently switch in response to a respective control signal, such as, for example, received from respective inputs A₀-A_{N-1}. Any of the switching elements SW₀-SW_{N-1} can be, for example, an n-channel FET (nFET), a p-channel FET (pFET), a JFET, and/or a BJT, etc. According to one embodiment, each of the switching elements SW₀-SW_{N-1} may be independently enabled or disabled, which is controlled by a respective control signal. For example, dependent upon the operating environment, some of the switching elements may be enabled (e.g., switched on) while the rest of the switching elements are disabled (e.g., switched off) during a switching cycle of the DC/DC converter. The duty cycle of the DC/DC converter may be a summation of a duty cycle of each switching element. In a particular embodiment, each of the switching elements is coupled to each other in parallel.

According to one embodiment, one or more parameters related to circuit operating conditions are determined, for example, by measurement or by external input. For a specific circuit topology, these parameters yield an estimate of power loss for each power switch depending on the switch size. The size of each variable switch determined and adjusted in order to minimize the total loss and/or maximize the efficiency of the DC/DC converter. These operations may be performed periodically or constantly, depending on the variations in circuit operating conditions.

The algorithm for adjusting switch size can be implemented in a variety of ways. For example, according to one embodiment, the operating conditions could be directly measured. A hardware controller, a software controller, or a combination of both may periodically or constantly adjust the switch size. Alternatively, the controller could receive some information about the load current (e.g. the state of a microprocessor, either active or stop-clock) and the desired output voltage (e.g. VID code) and determine the switch size without a need for direct measurements of circuit currents or voltages. Other configurations may exist.

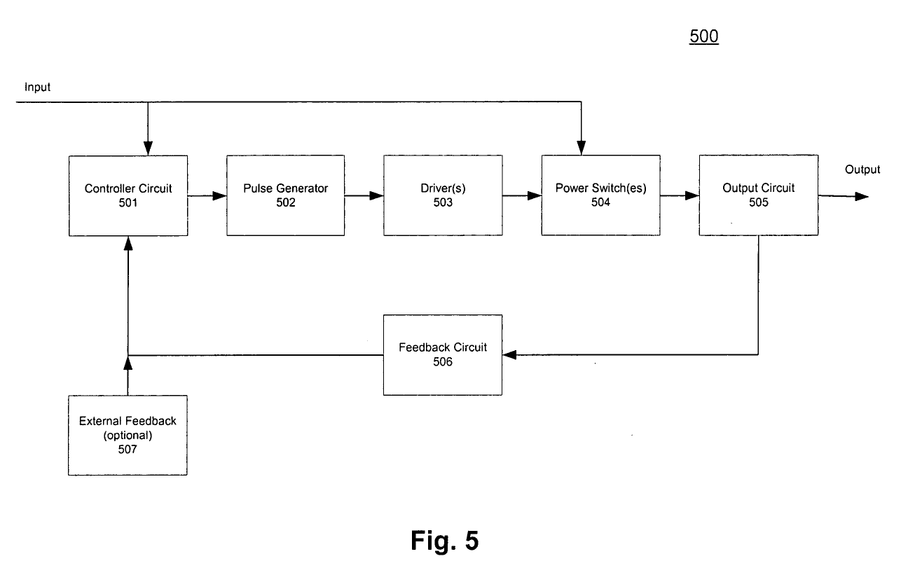

This technique may be applied to off-chip DC-DC converters implemented with multiple discrete power switches operating in parallel as well as partially or fully (monolithic) integrated DC-DC converters. In addition, if a portion of a switch is disabled, then the associated portion of the driver (e.g., driver circuits 503 of FIG. 5) may be disabled as well to further reduce power consumption.

This technique may be used in addition to other commonly used techniques, such as, for example, pulse-frequency mode (PFM), or variable number of active phases in multi-phase converters. Some or all phases may remain active, which results in smaller inductance and better transient response. In addition, the relative size of multiple power switches, for example, the ratio of high-side and low-side switch in a buck converter, may be adjusted to optimum for each V_{OUT}/V_{IN} ratio or operating frequency.

FIG. 5 is a block diagram illustrating a DC/DC converter having a power switch with variable size according to one embodiment. The DC/DC converter example 500 may be, for example, a buck converter, a Cuk converter, a flyback converter, a forward converter, or other types of DC/DC converters. In one embodiment, the DC/DC converter example 500 includes a controller circuit 501, a pulse generator 502, one or more driver circuits 503, one or more power switches 504, an output circuit 505, a feedback circuit 506, and an optional external feedback circuit 507.

In one embodiment, the controller circuit 501 receives input DC voltage and generates a clock signal having an appropriate duty cycle to enable output circuit 505 to provide a predetermined output voltage. In response to the clock signal received from the controller circuit, the pulse generator 502 may generate multiple signals having multiple pulses. In one embodiment, each of the multiple signals includes a pulse that may be used by one or more driver circuits 503 to drive one or more power switches 504.

In one embodiment, at least one power switch includes multiple switching elements that can be independently switched in response to a control signal. In a particular embodiment, the multiple switching elements may be coupled to each other in parallel. The duty cycle of the DC/DC converter example 500 may be determined by the duty cycle of each switching elements. Dependent upon the operating environment or conditions, at least a portion of the switching elements may be enabled (e.g., switched on) while the remaining switch elements may be disabled (e.g., switched off) within a switching cycle of the DC/DC converter.

In one embodiment, at least one of the one or more drivers 503 may be a stepwise driver include multiple switching elements. Each of the switching elements of the driver may be coupled to one of the pulse signals received from the pulse generator 502. In response to the multiple pulse signals, according to one embodiment, the multiple switching elements of the driver 503 may sequentially switch to charge a gate capacitance of a power switch 504 from a first voltage to a second voltage in multiple steps. That is, contrary to a conventional DC/DC converter, the gate capacitance of the power switch 504 may be charged to at least one intermediate voltage between the first and second voltages, before being charged to the second voltage within a charging cycle of a switching cycle of the DC/DC converter. Similarly, in response to the stepwise pulse signals, the multiple switching elements of the driver 503 sequentially switch in a reversed order to discharge the gate capacitance of the power switch 504 during a discharge phase of the switching cycle of the DC/DC converter. As a result, the power loss due to the gate capacitance may be reduced. The detailed information concerning a stepwise driver circuit may be found in a co-pending U.S. patent application No. XXXX, entitled “Stepwise Drivers for DC/DC Converters”, filed Aug. 16, 2004, and assigned to a common assignee of the present application.

Output circuit 505 may include a rectifier and/or a filtering circuit. Feedback circuit 506 may be used to provide output information to the controller circuit 501 to allow the controller circuit 501 to adjust, for example, the duty cycle of a next switching cycle of the converter. Optionally, the external feedback circuit 507 may be used to provide further feedback information from a device external to the converter; for example, a microprocessor of a computer system. Other components may also be included.

According to certain embodiments, the DC/DC converter example 500 may be implemented as several discrete components. Any of the components of the DC/DC example 500 may be packaged separately. Alternatively, some or all of the components of the DC/DC converter 500 may be packaged or integrated within a single package (e.g., an integrated chip). For example, driver circuits 503 and power switches 504 may be packaged or integrated on one chip.

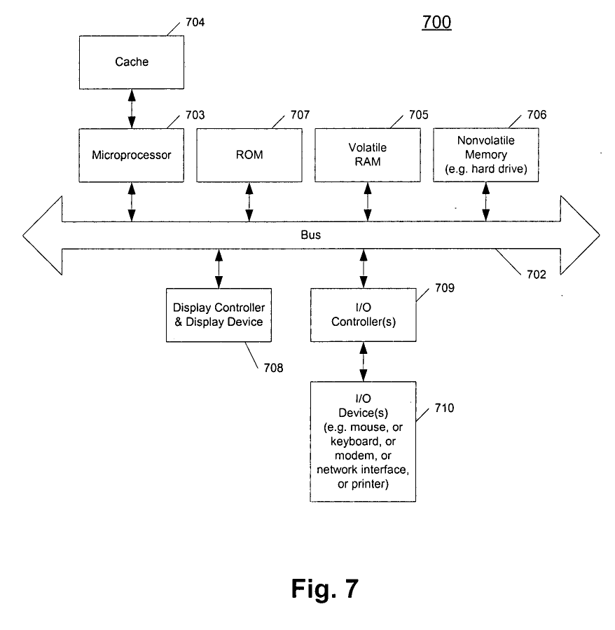

In a further embodiment, while the DC/DC converter example 500 may be implemented within one chip, the devices or circuits powered by the DC/DC converter example 500 may be located outside of chip having the DC/DC converter. Alternatively, some or all of the devices or circuits powered by the DC/DC converter may also be implemented within the same package of the DC/DC converter. For example, the DC/DC converter as shown in FIG. 5 may be integrated within the same chip of any of the components of a data processing system as shown in FIG. 7, which will be described in details further below.

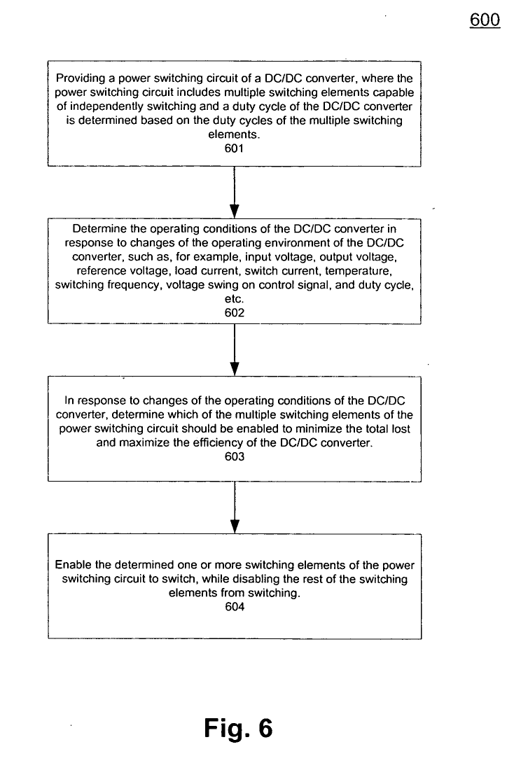

FIG. 6 is a flow diagram illustrating a process for operating a DC/DC converter according to one embodiment. The process example 600 may be performed by a processing logic that may comprise hardware (circuitry, dedicated logic, etc.), software (such as is run on a dedicated machine), or a combination of both. In one embodiment, the process example 600 includes, but is not limited to, generating a plurality of control signals, and independently controlling a plurality of switching elements of a power switching circuit of a DC/DC converter using the plurality of control signals to convert an input voltage to an output voltage of the DC/DC converter, a duty cycle of the DC/DC converter being determined based on a duty cycle of each of the switching elements.

Referring to FIG. 6, at block 601, a power switch having multiple switching elements of a DC/DC converter is provided, where each of the switching elements is capable of independently switching in response to a respective control signal. The power switch may be, for example, a power switch similar to the power switch example 400 of FIG. 4. The duty cycle of the DC/DC converter may be determined based on the duty cycle of each switching element. At block 602, the processing logic determines the operating conditions of the DC/DC converter in response to the changes of the operating environment of the DC/DC converter. For example, the operating conditions may be determined based on the input and output voltages, reference voltage, load current, switch current, temperature, switching frequency, voltage swing of the control signal, and duty cycle, etc. Alternatively, the operating conditions may be determined further based on one or more external factors, such as, for example, the operating states of a microprocessor of a data processing system.

At block 603, in response to the changes of the operating conditions of the DC/DC converter, the processing logic determines which of the multiple switching elements of the power switch should be enabled, in order to minimize the total loss and maximize the efficiency of the DC/DC converter. At block 604, in response to the determination, at least a portion of the switching elements are enabled within a switching cycle of the DC/DC converter while the rest of the switching elements are disabled. Other operations may also be performed.

FIG. 7 is a block diagram of a computer example which may be used with an embodiment. For example, some or all components of system 700 shown in FIG. 7 may be powered using one or more DC/DC converters similar to the DC/DC converter example shown in FIG. 5. Note that while FIG. 7 illustrates various components of a computer system, it is not intended to represent any particular architecture or manner of interconnecting the components, as such details are not germane to the present invention. It will also be appreciated that network computers, handheld computers, cell phones, and other data processing systems which have fewer components or perhaps more components may also be used with the present invention.

As shown in FIG. 7, the computer system 700, which is a form of a data processing system, includes a bus 702 which is coupled to a microprocessor 703 and a ROM 707, a volatile RAM 705, and a non-volatile memory 706. The microprocessor 703, which may be, for example, a Pentium processor from Intel Corporation or a PowerPC processor from Motorola, Inc., is coupled to cache memory 704 as shown in the example of FIG. 7. The bus 702 interconnects these various components together and also interconnects these components 703, 707, 705, and 706 to a display controller and display device 708, as well as to input/output (I/O) devices 710, which may be mice, keyboards, modems, network interfaces, printers, and other devices which are well-known in the art.

Typically, the input/output devices 710 are coupled to the system through input/output controllers 709. The volatile RAM 705 is typically implemented as static RAM (SRAM) or dynamic RAM (DRAM) which requires power continuously in order to refresh or maintain the data in the memory. The non-volatile memory 706 is typically a magnetic hard drive, a magnetic optical drive, an optical drive, or a DVD ROM or other type of memory system which maintains data even after power is removed from the system. Typically, the non-volatile memory will also be a random access memory, although this is not required. While FIG. 7 shows that the non-volatile memory is a local device coupled directly to the rest of the components in the data processing system, it will be appreciated that the present invention may utilize a non-volatile memory which is remote from the system; such as, a network storage device which is coupled to the data processing system through a network interface such as a modem or Ethernet interface.

The bus 702 may include one or more buses connected to each other through various bridges, controllers, and/or adapters, as is well-known in the art. In one embodiment, the I/O controller 709 includes a USB (Universal Serial Bus) adapter for controlling USB peripherals or a PCI controller for controlling PCI devices, which may be included in 10 devices 710. In a further embodiment, I/O controller 709 includes an IEEE-1394 controller for controlling IEEE-1394 devices, also known as FireWire devices. Other components may also be implemented.

In one embodiment, some or all of the components may be powered via one or more DC/DC converters. At least one DC/DC converter may be implemented similar to the DC/DC converter example 500 of FIG. 5. At least one DC/DC converter may include a power switch having multiple switching elements and each of the switch elements may independently switch in response to control signal. At least one power switch may be implemented similar to the power switch example 400 of FIG. 4.

Thus, DC/DC converters using dynamically adjusted variable size switches have been described. In the foregoing specification, the invention has been described with reference to specific exemplary embodiments thereof. It will be evident that various modifications may be made thereto without departing from the broader spirit and scope of the invention as set forth in the following claims. The specification and drawings are, accordingly, to be regarded in an illustrative sense rather than a restrictive sense.

What is claimed is:

1. A power switching circuit, comprising:
a plurality of switching elements coupled to each other, each of the switching elements independently switching to convert an input voltage to an output voltage of a DC/DC converter, and a duty cycle of the DC/DC converter being determined based on a duty cycle of each of the switching elements.

2. The power switching circuit of claim 1, further comprising an input circuit to receive a plurality of control signals to cause the plurality of switching elements to switch respectively.

3. The power switching circuit of claim 2, wherein each of the plurality of control signals is to drive each of the switching elements independently.

4. The power switching circuit of claim 2, wherein at least a portion of the switching elements are enabled while a remainder of the switching elements are disabled during a switching cycle of the DC/DC converter.

5. The power switching circuit of claim 4, wherein a number of the switching elements that are enabled by the respective control signals is determined based on one or more factors of an operating environment of the DC/DC converter.

6. The power switching circuit of claim 5, wherein the one or more factors include at least one factor selected from the group consisting of:
an input voltage;
an output voltage;
a reference voltage;
a load current;
a switching current;
temperature;
switching frequency; and
voltage swing of the control signals.

7. The power switching circuit of claim 1, wherein the plurality of switching elements are coupled to each other in parallel.

8. The power switching circuit of claim 1, wherein the duty cycle of the DC/DC converter is determined based on a summation of duty cycles of the switching elements.

9. A DC/DC converter, comprising:
an input circuit to receive an input voltage;
an output circuit to provide an output voltage; and
a power switching circuit coupled to the input and output circuits to convert the input voltage to the output voltage, the power switching circuit including
a plurality of switching elements coupled to each other, each of the switching elements independently switching, and a duty cycle of the DC/DC converter being determined based on a duty cycle of each of the switching elements.

10. The DC/DC converter of claim 9, further comprising one or more driver circuits to generate a plurality of control signals to cause the plurality of switching elements to switch respectively.

11. The DC/DC converter of claim 10, wherein each of the plurality of control signals is to drive each of the switching elements independently.

12. The DC/DC converter of claim 10, wherein at least a portion of the switching elements are enabled while a remainder of the switching elements are disabled during a switching cycle of the DC/DC converter.

13. The DC/DC converter of claim 12, wherein a number of the switching elements that are enabled by the respective control signals is determined based on one or more factors of an operating environment of the DC/DC converter.

14. The DC/DC converter of claim 10, further comprising one or more pulse generators coupled to the one or more driver circuits to generate a plurality of pulse signals, wherein the control signals are generated based on the plurality of pulse signals.

15. The DC/DC converter of claim 14, wherein at least two of the power switching circuit, driver circuits, and pulse generators are packaged in different packages.

16. The DC/DC converter of claim 14, wherein at least two of the power switching circuit, driver circuits, and pulse generators are packaged within a single package.

17. The DC/DC converter of claim 9, wherein one or more circuits that are powered by the DC/DC converter are packaged external to the DC/DC converter.

18. The DC/DC converter of claim 9, wherein one or more circuits that are powered by the DC/DC converter are packaged within the same package of the DC/DC converter.

19. The DC/DC converter of claim 13, wherein the one or more factors include at least one factor selected from the group consisting of:
an input voltage;
an output voltage;
a reference voltage;
a load current;
a switching current;
temperature;
switching frequency; and
voltage swing of the control signals.

20. The DC/DC converter of claim 9, wherein the plurality of switching elements are coupled to each other in parallel.

21. The DC/DC converter of claim 9, wherein the duty cycle of the DC/DC converter is determined based on a summation of duty cycles of the switching elements.

22. A data processing system, comprising:
a bus;
a processor coupled to the bus;
one or more devices coupled to the bus; and
a DC/DC converter to provide a supply voltage to at least one of the processor and the one or more devices, the DC/DC converter including
an input circuit to receive an input voltage,
an output circuit to provide an output voltage, and
a power switching circuit coupled to the input and output circuits to convert the input voltage to the output voltage, the power switching circuit including
a plurality of switching elements coupled to each other, each of the switching elements independently switching, and a duty cycle of the DC/DC converter being determined based on a duty cycle of each of the switching elements.

23. The data processing system of claim 22, wherein the DC/DC converter further comprises one or more driver circuits to generate a plurality of control signals to cause the plurality of switching elements to switch respectively.

24. The data processing system of claim 23, wherein each of the plurality of control signals is to drive each of the switching elements independently.

25. The data processing system of claim 23, wherein at least a portion of the switching elements are enabled while a remainder of the switching elements are disabled during a switching cycle of the DC/DC converter.

26. The data processing system of claim 25, wherein a number of the switching elements that are enabled by the respective control signals is determined based on one or more factors of an operating environment of the DC/DC converter.

27. The data processing system of claim 23, wherein the DC/DC converter further comprises one or more pulse generators coupled to the one or more driver circuits to generate a plurality of pulse signals, wherein the control signals are generated based on the plurality of pulse signals.

28. The data processing system of claim 27, wherein at least two of the power switching circuit, driver circuits, and pulse generators are packaged in different packages.

29. The data processing system of claim 27, wherein at least two of the power switching circuit, driver circuits, and pulse generators are packaged within a single package.

30. The data processing system of claim 22, wherein the at least one of the processor and the one or more devices powered by the DC/DC converter is packaged external to the DC/DC converter.

31. The data processing system of claim 22, wherein the at least one of the processor and the one or more devices powered by the DC/DC converter is packaged within the same package of the DC/DC converter.

32. The data processing system of claim 26, wherein the one or more factors include at least one factor selected from the group consisting of:
an input voltage;
an output voltage;
a reference voltage;
a load current;
a switching current;
temperature;
switching frequency; and
voltage swing of the control signals.

33. The data processing system of claim 22, wherein the plurality of switching elements are coupled to each other in parallel.

34. The data processing system of claim 22, wherein the duty cycle of the DC/DC converter is determined based on a summation of duty cycles of the switching elements.

35. A method, comprising:
generating a plurality of control signals; and
independently controlling a plurality of switching elements of a power switching circuit of a DC/DC converter using the plurality of control signals to convert an input voltage to an output voltage of the DC/DC converter, a duty cycle of the DC/DC converter being determined based on a duty cycle of each of the switching elements.

36. The method of claim 35, further comprising:
receiving information regarding operating environment of the DC/DC converter; and
determining one or more operating conditions of the DC/DC converter based on the received information, wherein the plurality of control signals are generated based on the determined one or more operating conditions.

37. The method of claim 36, further comprising:
determining at least a portion of the switching elements that should be enabled based on the determined one or more operating conditions; and
enabling via the control signals the determined portion of the switching elements while disabling a remainder of the switching elements.

38. The method of claim 37, wherein the duty cycle of the DC/DC converter is a summation of duty cycles of the switching elements that are enabled.
